(19) United States
(12) Patent Application Publication
(10) Pub. No.: US 2022/0373525 A1
(43) Pub. Date: Nov. 24, 2022

(54) COLORIMETRIC DETECTOR

(71) Applicant: FUNDACIÓN IMDEA NANOCIENCIA, Madrid (ES)

(72) Inventors: José SÁNCHEZ COSTA, Madrid (ES); Esther RESINES URIÉN, Madrid (ES); Arturo GAMONAL RUIZ-CRESPO, Madrid (ES); Lucia PIÑEIRO, Madrid (ES)

(21) Appl. No.: 17/640,591

(22) PCT Filed: Sep. 4, 2020
(86) PCT No.: PCT/EP2020/074768

§ 371 Date: Mar. 4, 2022

(30) Foreign Application Priority Data
Sep. 5, 2019 (EP) 19382761.5

(51) Int. Cl. G01N 31/22; C08L 33/12; C08G 79/00; G01N 21/78

(52) U.S. Cl. CPC G01N 31/22; C08L 33/12; C08G 79/00; G01N 21/78

(57) ABSTRACT

The present invention is related to the detection of formaldehyde concentrations in the air by using a coordination polymer, which comprises repeating coordination complexes with an octahedral geometry, wherein said coordination complex comprises iron (II), at least one ligand comprising an amino moiety; wherein the coordination polymer further comprises counter-ions; for the identification and/or quantification of formaldehyde.

### FIELD OF THE INVENTION

This invention relates to the detection of formaldehyde, more preferably to the detection of formaldehyde concentrations in the air. The type of detection involved is a colorimetric reaction wherein the color intensity is proportional to the amount of formaldehyde. The colorimetric response can be read with standard spectroscopic techniques, such as NMR or reflectance spectrophotometers, or visually by the human naked-eye using color comparison standards.

### BACKGROUND

The Sick Building Syndrome (SBS) is defined as a medical condition in which the occupants of a building suffer acute health- or comfort-related effects, such as headache, mucous irritation (eyes, nose and throat), dry or itching skin, fatigue, difficulty in concentration, sensitivity to odors, cold, flu-like symptoms, dizziness and nausea for no apparent reason. Said symptoms seem to be linked directly to the time spent in the building. In 1984 the WHO reported that up to 30% of new and remodeled buildings worldwide may have poor indoor air quality. Although the cause of the symptoms is not known, most of the patients report relief soon after leaving the building. Some of the plausible factors that might be primarily responsible for SBS are chemical contaminants from outdoor sources (pollutants from motor vehicle exhaust, plumbing vents and building exhausts from bathrooms and kitchens). From indoor sources, the most common contaminant of indoor air includes volatile organic compounds (VOCs) with the main sources being adhesives, paint, upholstery, carpeting, pesticides, cleaning agents and manufactured wood products. Formaldehyde, a widely used compound in household materials and industrial processes, has been classified as a human carcinogen by the World Health Organization (WHO) (https://monographs.iarc.fr/wp-content/uploads/2018/09/ClassificationsAlphaOrder.pdf) and identified as a major cause of sick building syndrome (SBS) (S. M. Joshi, Indian J. Occup. Environ. Med. 2008, 12, 61-64).

Currently available means for detecting formaldehyde include, among others, electrochemical gas sensors where the target gas undergoes electrochemical reactions with a given electrolyte. The resulting current can be measured and, most important, is related to the concentration of the gas in the sample. For example, NE4-Electrochemical Formaldehyde (HCHO) Gas Sensor (commercialized by Nemoto Sensor Engineering Company Ltd.), or Formaldehyde Detector XP-308B (commercialized by New Cosmos) are portable and user friendly devices, however expensive (around 150 €).

Years ago, the mixture comprising the reagent and additives was exposed to the target gas and illuminated with light emitting diodes (LEDs). The light intensity after passage through the sample and operational amplifiers was measured with photodiodes, to yield a directly proportional output voltage, i.e. a transmittance measurement that can be translated in terms of absorbance; hence, the concentration of formaldehyde was estimated according to the Beer-Lambert Law.

More recently, an optic spectrometer allowed to record the degree of color change by measuring the intensity of the reflecting light. In order to perform quantitative estimations, the reflectance spectrum obtained before and after exposure to formaldehyde gas has to be converted into RGB (red, green and blue) values, the resulting color-change profile helps to determine the concentration of formaldehyde. The optical modification is usually triggered by a reaction between an amine group and formaldehyde, particularly a nucleophilic addition, which yields the corresponding imine and water. The changes in basicity due to this transformation can be related to the amount of formaldehyde (Suslick, K. S. et al., J. Am. Chem. Soc., 2010, 132, 4046-4047). Moreover, in some cases, an acid can be added and its protonation might increase the pH of the media (Li., J. et al., Sensors and Actuators B, 2014, 196, 10). In these circumstances, the detection of formaldehyde in the sample is done by pH indicators.

The well-known Metal Organic Frameworks (MOFs), i.e. organic linkers coordinated to metal sites building up three-dimensional structures, are materials currently studied for constructing chemical sensing devices. MOFs based on octahedral complexes featuring transition metal ions with 3d⁴-3d⁷ electronic configurations are particularly alluring. These materials can exhibit reversible switching between the low spin (LS) and high spin (HS) states in response to several stimulus, such as a variation in temperature or pressure, light irradiation, a magnetic field or the uptake of guest molecules. The phenomenon is known as the spin crossover (SCO) phenomenon, and the electronic changes are intrinsically related with structural modifications that deeply affect the physical properties displayed by the SCO material.

Fe(pyrazine)[Pt(CN)₄] is a paramount example of SCO MOF which undergoes HS→LS spin transition when absorbing CS₂. On the contrary, the uptake of benzene turns the system back to the HS state. Even more remarkable is that the CS₂ derivative, displaying the LS spin state, is red. However, when benzene molecules fill the pores instead, the material becomes yellow as it displays the HS state (Ohba, M. et al., Angew. Chem. Int. Ed., 2009, 48, 4767-4771).

Another example is the compound of discrete formula [Fe(L-NH₂)₂].H₂O (HL-NH₂=2-pyridinecarbaldehyde(4′-aminobenzoyl)hydrazone), which displays an amino functional group capable of reacting with formaldehyde (Chen, X.-Q. et al., Inorg. Chem. 2019, 58, 2, 999-1002). Notably, this compound changed its color too upon exposure to HCl and HAc vapors, and recovered after exposure to amine.

Although current commercial colorimetric methods, based on color changes arising from the specific chemical reaction between formaldehyde and a certain reagent, are an excellent alternative and the optical modification can be related to the concentration of formaldehyde, the reagents are generally used in a mixture with other ingredients such as stabilizers or buffers. On top of that, some of the examples known in the literature release dangerous compounds, such as sulfuric acid, or requires the use of heavy metals. In other cases the detection method requires signal and data processing. When the detection method is based in a reversible reaction or process, the results of the assay cannot be manipulated. Therefore, from all the above, it is clear that a simple, safer, non-reversible, more selective and low-cost alternative approach is needed.

The present invention relates to the novel chemistry and use of a SCO compound and its implementation in a portable, hand-held device that allows for a fast identification and/or quantitative analysis of formaldehyde. It does not require the use of complicated apparatus, harmful chemicals, expensive reagents or materials, and no signal or data processing is required either. Additionally, the reaction involved is highly selective, non-reversible, and so is the change in color; hence the assay results cannot be manipulated and are completely reliable.

### BRIEF DESCRIPTION OF THE INVENTION

In a first aspect, the present invention is directed to the use of a coordination polymer, wherein the coordination polymer comprises repeating coordination complexes with an octahedral geometry, wherein said coordination complex comprises iron (II), at least one ligand comprising an amino moiety; wherein the coordination polymer further comprises counter-ions; for the identification and/or quantification of formaldehyde.

In a second aspect, the present invention is directed to a composite material, wherein said composite comprises a coordination polymer, wherein said coordination polymer comprises repeating coordination complexes with an octahedral geometry, wherein said coordination complex comprises iron (II), at least one ligand comprising an amino moiety, wherein the at least one ligand comprising an amino moiety comprises a primary amine (NH₂); preferably wherein the at least one ligand is (NH₂Trz) and wherein the coordination polymer further comprises counter-ions comprising an aromatic moiety; and a matrix; wherein the coordination polymer of the invention is embedded in and/or coating the matrix.

In a third aspect, the present invention is directed to the use of the composite material as defined above for the identification and/or quantification of formaldehyde, by a detectable spectroscopic response such as a colorimetric response that can be detected by the human naked-eye.

In a fourth aspect, the present invention is directed to a hand-held portable device comprising the composite as defined above and a suitable case.

A fifth aspect of the invention is directed to the use of a hand-held portable device for the identification and/or quantification of formaldehyde by detectable spectroscopic response, such as a colorimetric response that can be detected by the human naked-eye.

In a sixth aspect, the present invention is directed to a method for the identification and/or quantification of formaldehyde, wherein the method comprises contacting either:
a coordination polymer;
a composite material comprising said coordination polymer and a matrix; wherein the coordination polymer is embedded in and/or coating the matrix, or
a hand held device comprising the composite material and a suitable case;
with a gaseous, liquid or solid analyte to produce a non-reversible reaction, wherein said reaction produces a detectable spectroscopic response, such as a colorimetric response that can be detected by the human naked-eye; wherein the coordination polymer comprises repeating coordination complexes with an octahedral geometry, wherein said coordination complex comprises:
   iron(II); and
   at least one ligand comprising an amino moiety;
      wherein the coordination polymer further comprises counter-ions.

Finally, a seventh aspect of the invention is directed to a process for preparing the composite of the second aspect, comprising the following steps: i) providing a matrix; preferably a polymeric matrix; ii) providing the coordination polymer as defined in the second aspect; iii) combining the matrix (i) and the coordination polymer (ii); preferably by mixing them or by coating the matrix with the coordination polymer.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the pertinent art to make and use the invention.

FIG. 1. Illustrates the scheme of reaction between compound 1 and formaldehyde to yield compound 2.

FIG. 2. ¹H NMR spectra of compounds 1 and 2 after digestion.

FIG. 3. Infrared spectrum of compounds 1 and 2, OTs⁻ and formaldehyde, between 4000 and 400 cm⁻¹: compound 1 [3229 cm⁻1 v(NH), 3104 cm⁻¹ v(CH), 1527 cm-1 δ(CCC), 618 cm⁻¹ (C—H)]; OTs⁻[1034-1006 cm⁻¹ d(CCC)ᵢₚ, v(CC), vs(SO₃), 812 cm⁻¹ δ(CCC)ᵢₚ, vs(S03) 673 cm⁻¹ δ₍ₒₒₚ₎ₛ(SO3), δ(CCC)ᵢₚ]; HCHO [1645 cm⁻¹ v(CO)]; compound 2 [1659 v(CN)].

FIG. 4. Illustrates the optical reflectivity vs. T of compounds 1 (black squares) and 2 (grey round dots).

FIG. 5. ¹H NMR spectra of compounds 1, 3, 4 and 5.

FIG. 6. Illustrates the optical reflectivity vs. T.

FIG. 7. Illustrates the optical reflectivity vs. time.

Embodiments of the present invention will be described with reference to the accompanying drawings.

### DETAILED DESCRIPTION OF THE INVENTION

It should be understood that the scope of the present disclosure includes all the possible combinations of embodiments disclosed herein.

In a first aspect, the invention is directed to the use of a coordination polymer, wherein the coordination polymer comprises repeating coordination complexes with an octahedral geometry, wherein said coordination complex comprises iron (II), at least one ligand comprising an amino moiety, wherein the coordination polymer further comprises counter-ions; for the identification and/or quantification of formaldehyde.

The term “coordination polymer” in the present invention is directed to an inorganic or organometallic polymeric structure comprising metal cation centers linked by ligands; it is understood that “coordination polymer” refers to a coordination compound with repeating coordination entities extending in 1, 2 or 3 dimensions.

In the present invention, iron (II) refers to a cationic iron in oxidation state +2.

The expression “at least one ligand comprising an amino moiety”, in the present invention, refers to a ligand containing at least one basic nitrogen atom with a lone electron pair, further comprising three substituents, such as three hydrogen atoms; alternatively, it comprises two hydrogen atoms and one alkyl or aryl substituent or a side chain; alternatively, it comprises one hydrogen atom and two alkyl or aryl substituents or side chains; alternatively, it comprises up to three alkyl or aryl substituents or side chains. Non-limiting examples of ligands comprising an amino moiety are aniline, 4-amino-1,2,4-triazole (NH₂Trz), 3-amino-1,2,4-triazole.

In the present invention, the repeating coordination complexes with an octahedral geometry comprising an iron (II) is coordinated to at least one ligand comprising an amino moiety; preferably, the iron (II) is coordinated to at least two ligands each one comprising an amino moiety; even more preferably, the iron (II) is coordinated to at least three ligands each one comprising an amino moiety. In order to complete the coordination sphere of the iron (II) center of the present invention, 6 coordination atoms have to arrange in a suitable spatial geometry. Therefore, in non-limiting examples, either 6 terminal ligands such as monodentate ligands, or 3 bidentate ligands, or 2 tridentate ligands, or any suitable combination of the previous, such as 4 monodentate ligands and one bidentate ligand, coordinate to the iron (II) center, wherein at least one of said ligands comprises an amino moiety. In the present invention, the term “denticity” of a ligand is defined by the number of times a ligand binds to a metal center by non-contiguous donor sites. Bridging ligands, which connect at least two metal ions, can also be arranged around the metal center in the coordination sphere.

As disclosed in the first aspect, the coordination polymer comprises repeating coordination complexes, and further comprises counter-ions. In the present invention, the expression “counter-ion(s)” refers to the ion or ions that neutralize the electronic charge of another ionic species; such as a coordination complex.

In an embodiment, counter-ions comprise an aromatic moiety or an ion selected from fluoride (F⁻), chloride (Cl⁻), bromide (Br⁻), iodide (I⁻) and a combination thereof; preferably comprise an ion selected from fluoride (F⁻), chloride (Cl⁻), bromide (Br⁻), iodide (I⁻) and a combination thereof; more preferably chloride (Cl⁻) or bromide (Br⁻); even more preferably bromide (Br⁻).

In a particular embodiment, the counter-ions comprise an aromatic moiety. In the present invention, the expression “comprising an aromatic moiety” regarding the counter-ions refers to said ions comprising an aromatic ring comprising between 5 and 12 atoms; wherein the atoms can be either carbon or heteroatoms such as O, N, S. Non-limiting examples of counter-ions comprising an aromatic moiety are para-toluenesulfonate, orto-toluenesulfonate, para-hydroxybenzoate, or meta-hydroxybenzoate. The coordination polymer of the present invention comprises as many counter-ions as necessary to neutralize the electric charge of the coordination complexes.

As used herein, the term “alkyl” refers to a linear or branched saturated hydrocarbon chain radical, or a saturated or partially saturated cyclic aliphatic group, consisting of carbon and hydrogen atoms, preferably comprising between 1 and 6 carbon atoms, and which is attached to the rest of the molecule by a single bond. The term “aryl” refers to an aromatic cyclic group having between 5 and 12 carbon atoms, which can also comprise other substituents, including for example and in a non-limiting sense, phenyl, naphthyl, o-tolyl, p-tosyl, etc. The term “side chain”, describes any chemical group that is attached to a core part of a molecule, or backbone, and includes alkyl, alkenyl, alkynyl, aryl and heterocyclic groups containing substituents at one or more available positions by one or more suitable groups such as OR, ═O, SR, SOR, SO₂R, NO₂, NHR, N(R)₂, ═N—R, NHCOR, N(COR)₂, NHSO₂R, NRC(═NR)NRR, CN, halogen, COR, COOR, OCOR, OCONHR, OCON(R)₂, CONHR, CON(R)₂, wherein each of the R groups is independently selected from the group consisting of hydrogen, OH, NO₂, NH₂, SH, CN, halogen, COH, CO-alkyl, COOH, substituted or unsubstituted C₁-C₁₂ alkyl, substituted or unsubstituted C₂-C₁₂ alkenyl, substituted or unsubstituted C₂-C₁₂ alkynyl, substituted or unsubstituted aryl, and substituted or unsubstituted heterocyclic group.

The term “coordination complex”, as disclosed in the present invention, consists of a coordination center and a surrounding array of ligands. The coordination center is a central atom or ion, usually a metal, in particular a transition metal. In these cases, the coordination complex is called a metal complex. Ligands are bound to the coordination center generally by a coordinate covalent bond by electron donation from a lone electron pair into an empty orbital of the metal center.

The octahedral molecular geometry referred herein, in which six ligands are symmetrically or almost symmetrically arranged around a central atom to define the vertices of an octahedron, is a particular case of metal coordination. The bonding, orbital arrangement, and other characteristics of metal coordination complexes based on the geometry of the complex, are described according to the Ligand Field Theory (LFT). Hence, the coordination polymer comprising repeating coordination complexes comprising iron (II) with an octahedral geometry, as disclosed in the present invention, refers to a coordination polymer comprising a polymeric iron (II) based system, displaying a backbone of linearly arranged iron (II) ions connected by ligands. The coordination polymer of the present invention comprises at least three coordination complexes {[Fe(NH₂Trz)₃](OTs)₂}₃.

In a particular embodiment, the at least one ligand comprising an amino moiety, preferably comprises a primary amine; more preferably comprises a primary amine and an azole moiety; even more preferably comprises a primary amine and a triazole moiety.

In a particular embodiment, the at least one ligand comprising an amino moiety is selected from aniline, 4-amino-4H-1,2,4-triazole (NH₂Trz) and 3-amino-1,2,4-triazole; preferably is (NH₂Trz)=4-amino-4H-1,2,4-triazole.

In a particular embodiment, the at least one ligand comprising an amino moiety comprises a primary amine (NH₂); preferably is selected from aniline, 4-amino-4H-1,2,4-triazole (NH₂Trz) and 3-amino-1,2,4-triazole; preferably is (NH₂Trz)=4-amino-4H-1,2,4-triazole.

In another particular embodiment, the counter-ions comprising an aromatic moiety of the coordination polymer further comprises a sulfonate group; preferably the counter ion is an alkyl benzene sulfonate; more preferably an C₁₋₉ alkyl benzene sulfonate; even more preferably an C₁₋₃ alkyl benzene sulfonate; even much more preferably p-toluenesulfonate or tosylate (OTs).

In another particular embodiment, the counter-ions comprising an aromatic moiety of the coordination polymer are (OTs)=para-toluenesulfonate; preferably methyl 4-methylbenzenesulfonate.

In a particular embodiment, the preferred coordination polymer comprising repeating coordination complexes with an octahedral geometry, wherein said coordination complexes comprise iron (II) and at least one ligand comprising an amino moiety, and wherein the coordination polymer further comprises a counter-ion comprising an aromatic moiety is {[Fe(NH₂Trz)₃](OTs)₂}ₙ wherein n≥3, and wherein (NH₂Trz)=4-amino-4H-1,2,4-triazole, and (OTs)=para-toluenesulfonate.

In a preferred embodiment, the preferred coordination polymer is {[Fe(NH₂Trz)₃](OTs)₂}ₙ, wherein n is comprised between 3 and infinity; preferably n is comprised between 3 and 10³; alternatively n is comprised between 3 and 10⁶; even more preferably, n could also be comprised between 3 and 10⁹.

As described herein, the coordination polymer of the present invention that could be represented by the formula {[Fe(NH₂Trz)₃](OTs)₂}ₙ, wherein n≥3, comprising a non-coordinated amino pendant group is free to undergo post synthetic covalent modifications.

In a particular embodiment, the coordination polymer of the present invention further comprises interstitial coordination water molecules and could be represented by the formula {[Fe(NH₂Trz)₃](OTs)₂}ₙ.xH₂O, wherein n3 and x is between 0 and 20, preferably, x is between 0 and 10, more preferably x is between 0 and 2.

In another particular embodiment, the coordination polymer of the present invention further comprises interstitial coordination water molecules and could be represented by the formula {[Fe(NH₂Trz)₃](OTs)₂}ₙ.xH₂O,

wherein n is between 3 and 10³ and x is between 0 and 20; alternatively n is between 3 and 10⁶ and x is between 0 and 20; alternatively n is between 3 and 10⁹ and x is between 0 and 20.

Preferably, n is between 3 and 10³ and x is between 0 and 10; alternatively n is between 3 and 10⁶ and x is between 0 and 10; alternatively n is between 3 and 10⁹ and x is between 0 and 10;

Even more preferably, n is between 3 and 10³ and x is between 0 and 2; alternatively, n is between 3 and 10⁶ and x is between 0 and 2; alternatively, n is between 3 and 10⁹ and x is between 0 and 2.

The coordination polymer of the invention, as previously described, produces a detectable spectroscopic response when reacted with formaldehyde; preferably a colorimetric response detectable by the human naked-eye. It is preferred that said colorimetric response detectable by the human naked-eye takes place at room temperature, which in the present invention is a comfortable and normal to be in temperature, which can range from 18 to 30° C. depending on the area and the latitude. However, in a scientific context it is usually between 21-25° C. (294.15-298.15 K). Generally, the room temperature value accepted in scientific work corresponds to 25° C. (298.15 K).

The expression “spectroscopic response” as described in the present invention, refers to a detectable, measurable response resulting from the absorption and/or release of energy, which is directly related to the chemical structure of the studied compound. Spectroscopy is the field that studies the interaction between matter and electromagnetic radiation, including radio waves, microwaves, infrared, visible light, ultraviolet, X-rays, and gamma rays. Visible light refers to the visible spectrum that is visible to the human eye. Daily observations of color can be related to spectroscopy; for example, the color of chemicals comes in many cases from the excitation of electrons due to an absorption of energy. In particular, when the release of energy is in the range of approximately 380 nm to 760 nm, it is visible to the human eye. In this sense, the term “colorimetric response detectable by the human naked-eye” refers to a spectroscopic response due to the absorption and/or release of energy, wherein the electromagnetic radiation released is in the human visible range of the spectrum and can be visible to the naked eye without the aid of an spectroscopic detector such as a photomultiplier, or a semiconductor radiation detector.

The World Health Organization (WHO) regulates that the safety limit of formaldehyde for humans is 80 ppb; the Occupational Safety and Health Administration also stablished the immediately dangerous limit to life of health as 20 ppm of formaldehyde. The coordination polymer of the present invention, as previously described, is directed to an immediate assessment of potential risk and danger and produces a detectable spectroscopic response ranging from as low as 1 ppb of formaldehyde; it allows to colorimetrically detect as low as 3 ppb by the human naked-eye and over 80 ppb; even over 20 ppm. The quantification can be done broadly by comparison with a concentration colored map; spectroscopic detectors are able to provide precise concentrations if necessary.

In a second aspect, the invention is directed to a composite material, wherein said composite comprises a coordination polymer, wherein the coordination polymer comprises repeating coordination complexes with an octahedral geometry, wherein said coordination complex comprises iron (II), at least one ligand comprising an amino moiety, wherein the at least one ligand comprising an amino moiety comprises a primary amine (NH₂); preferably is (NH₂Trz), wherein the coordination polymer further comprises counter-ions comprising an aromatic moiety; and a matrix, wherein the coordination polymer is embedded in and/or coating the matrix.

In the context of the present invention, the term “matrix” refers to any organic or inorganic fine material, preferably the matrix is an organic or inorganic solid material.

In a particular embodiment, the matrix in which the compound is embedded in, or coated by the compound, can be an organic or inorganic thermostable compound. “Thermostable matrix” refers to a substance particularly able to resist irreversible chemical or physical changes when exposed to a high relative temperature. Preferably the matrix is an organic or inorganic thermostable compound. Non-limiting examples of an organic matrix are polymers such as PMMA, polyester, polystyrene, polyurethane or phenolic resins, or paper; non-limiting examples of an inorganic matrix are calcium carbonate, calcium sulfate, plaster, aluminosilicates, clay, zeolites, silica, or glass, among others. More preferably, the matrix is a thermostable polymer which remains stable at temperatures over 100° C., even more preferable the matrix is stable over 150° C. Most preferably, the matrix is stable at temperatures over 200° C. Even more preferably, the matrix comprises an acrylic or acrylate polymer; preferably an acrylate polymer selected from methacrylates, methylacrylates, ethylacrylates, butylacrylates eethylacrylates, butyl methacrylates and combinations thereof; more preferably is poly(methyl methacrylate) (PMMA).

In a particular embodiment, the matrix consist of an acrylic or acrylate polymer; preferably an acrylate polymer selected from methacrylates, methylacrylates, ethylacrylates, butylacrylates eethylacrylates, butyl methacrylates and combinations thereof; more preferably is poly(methyl methacrylate) (PMMA).

In a particular embodiment, the at least one ligand comprising an amino moiety comprises a primary amine (NH₂); preferably is selected from aniline, 4-amino-4H-1,2,4-triazole (NH₂Trz) and 3-amino-1,2,4-triazole; more preferably 4-amino-4H-1,2,4-triazol (NH₂Trz).

In an embodiment, the coordination polymer comprising repeating coordination complexes comprised in the composite is {[Fe(NH₂Trz)₃](y)ₘ}ₙ with n≥3, preferably n is between 3 and 10³, or n is between 3 and 10⁶, alternatively n is between 3 and 10⁹; more particularly the compound is {[Fe(NH₂Trz)₃](Br)₂}ₙ.xH₂O, wherein preferably n is between 3 and 10³, or n is between 3 and 10⁶, alternatively n is between 3 and 10⁹, x refers to the number of residual interstitial water molecules, which is selected from a value between 0 and 20 and y is any counter ion as defined in the present invention and m is the number of counter ions necessary to neutralize the electronic charge of the coordination complexes.

In a preferred embodiment, the coordination polymer comprising repeating coordination complexes comprised in the composite is {[Fe(NH₂Trz)₃](OTs)₂}ₙ with n≥3, preferably n is between 3 and 10³, or n is between 3 and 10⁶, alternatively n is between 3 and 10⁹; more particularly the compound is {[Fe(NH₂Trz)₃](OTs)₂}ₙ.xH₂O, wherein preferably n is between 3 and 10³, or n is between 3 and 10⁶, alternatively n is between 3 and 10⁹, and x refers to the number of residual interstitial water molecules, which is selected from a value between 0 and 20. The most preferable composite of the present invention comprises the coordination polymer {[Fe(NH₂Trz)₃](OTs)₂}ₙ.xH₂O, wherein preferably n is between 3 and 10³, or n is between 3 and 10⁶, alternatively n is between 3 and 10⁹, and x is between 0 and 20, and a thermostable polymeric matrix, in particular poly(methyl metacrylate) (PMMA), wherein the coordination polymer is embedded in the matrix or coating it. The composite can further comprise other components; non-limiting examples are dyes or preservatives.

In an alternative preferred embodiment, the coordination polymer comprising repeating coordination complexes comprised in the composite is {[Fe(NH₂Trz)₃](Br)₂}ₙ with n≥3, preferably n is between 3 and 10³, or n is between 3 and 10⁶, alternatively n is between 3 and 10⁹; more particularly the compound is {[Fe(NH₂Trz)₃](Br)₂}ₙ.xH₂O, wherein preferably n is between 3 and 10³, or n is between 3 and 10⁶, alternatively n is between 3 and 10⁹, and x refers to the number of residual interstitial water molecules, which is selected from a value between 0 and 20.

In a third aspect, the present invention is directed to the use of the composite as defined above for the identification and/or quantification of formaldehyde.

More preferably the identification and/or quantification is performed by a detectable spectroscopic response, such as infrared (IR) or nuclear magnetic resonance spectroscopy. Even more preferably, the detectable spectroscopic response is a colorimetric change, wherein the electromagnetic radiation released is in the human visible range of the spectrum and can be visible to the naked eye.

In a fourth aspect, the invention is directed to a hand-held portable device comprising the composite as defined above and a suitable case. Hand-held portable devices are designed to be held and used in the hands, are light and small enough to be easily carried around and stored. Non-limiting examples of hand-held portable devices are a colorimetric test strip, a colorimetric test kit, a colorimetric tube, a film comprising a colorimetric reagent, a small piece of a stiff material comprising a colorimetric reagent in a removable case or confined in a container comprising a porous component, e.g. a membrane, that can be exposed to the environment after removal of a protective item.

A fifth aspect is directed to the use of the composite of the present invention for the identification and/or quantification of formaldehyde by a detectable spectroscopic response. In a preferred embodiment, the identification and/or quantification of formaldehyde is performed visually by a colorimetric change detectable by the human naked-eye from a concentration of about 3 ppb to 20 ppm of formaldehyde and higher.

In a sixth aspect, the present invention is directed to a method for the identification and/or quantification of formaldehyde, said method comprising contacting either:
a coordination polymer;
a composite material comprising said coordination polymer and a matrix; wherein the coordination polymer is embedded in and/or coating the matrix, or
a hand held device comprising the composite material and a suitable case;
with a gaseous, liquid or solid analyte to produce a non-reversible reaction, wherein said reaction produces a detectable spectroscopic response, such as a colorimetric response that can be detected by the human naked-eye; wherein the coordination polymer comprises repeating coordination complexes with an octahedral geometry, wherein said coordination complex comprises:
   iron(II); and
   at least one ligand comprising an amino moiety;
      wherein the coordination polymer further comprises counter-ions.

In an embodiment, the spectroscopy response is a colorimetric response, preferably a color; more preferably a color defined by RGB values.

In a particular embodiment, the method comprises further comprises the following steps: i) contacting either the coordination polymer or the composite of the present invention, as defined above, and a analyte or a sample; ii) detecting the color displayed by the coordination polymer or the composite after being in contact with the sample of step (i); and/or iii) comparing the color obtained with a concentration colored map and/or measuring the intensity of said color.

In a more particular embodiment, if the color of step (ii) is comprised in the concentration colored map, then, the analyte or sample comprises formaldehyde. In an even more particular embodiment, the color of step (ii) is converted into RGB values and if the RGB values are comprised between a known RGB values range, the formaldehyde in the analyte or the sample is detected and/or quantified.

In an embodiment, the sample or analyte comprises formaldehyde.

In a more particular embodiment, the RGB values of the color obtained and the RGB values of the concentration colored map are compared. In an embodiment, RGB values are Red, Green and Blue color values as known in the art.

In a particular embodiment, the coordination polymer embedded in or coating the matrix is contacted with a gaseous, liquid or solid sample or analyte to produce a non-reversible reaction.

Preferably, the color obtained is converted into RGB values and is compared with a concentration colored map generated by converting the reflectance spectra of several coordination polymer or composites which have been contacted with well-defined, known concentrations of formaldehyde into RGB values. In an embodiment, a control image is subtracted from the concentration colored map.

In an embodiment, the counter-ions of the coordination polymer of the method comprise an aromatic moiety or an ion selected from fluoride (F⁻), chloride (Cl⁻), bromide (Br⁻), iodide (I⁻) and a combination thereof; preferably chloride (Cl⁻) or bromide (Br⁻); more preferably bromide (Br⁻).

In a particular embodiment, the counter-ions of the coordination polymer of the method comprise an aromatic moiety; preferably the counter-ions are tosylate counter-ions.

In a more particular embodiment, the coordination polymer is {[Fe(NH₂Trz)₃](OTs)₂}ₙ.xH₂O, wherein x is between 0 and 20, and wherein (NH₂Trz)=4-amino-4H-1,2,4-triazole, and (OTs)=para-toluenesulfonate.

In a seventh aspect, the invention is directed to a process for preparing the composite as defined above, comprising the following steps:
i) providing a matrix; preferably a polymeric matrix;
ii) providing the coordination polymer as defined above;
iii) combining the matrix (i) and the coordination polymer (ii); preferably by mixing them or by coating the matrix with the compound.

The embodiments described herein are representative only and are not intended to be limiting. Variations, combinations and modifications are possible and are within the scope of the disclosure. Accordingly, the scope of protection is not limited by the description set out above, but is defined by the claims which follow that scope including all equivalents of the subject matter of the claims.

### Example 1

### Synthesis of Coordination Polymer 1:

Coordination polymer (CP) of formula {[Fe(NH₂Trz)₃](OTs)₂}ₙ.xH₂O (Compound 1), in which the non-coordinated amino substituents in (NH₂Trz) are free to undergo post synthetic covalent modifications, thereby generating a new CP displaying different chemical functionalities which ultimately leads to diverse physical and chemical properties, was synthetized in two steps at room temperature.

Firstly, 0.20 mmol of Fe(OTs)₂ (OTs=tosylate) were dissolved in 3 mL of distilled water. After that, the Fe(OTs)₂ aqueous solution was added dropwise to a solution of containing 0.59 mmol of aminotriazole dissolved in 3 mL of ethanol. The H₂O:EtOH solution of Fe(OTs)₂/aminotriazole was stirred for 5 minutes, filtered and left in the freezer overnight. 1 was obtained as a pink powder in 60% yield.

### Synthesis of Coordination Polymer 2:

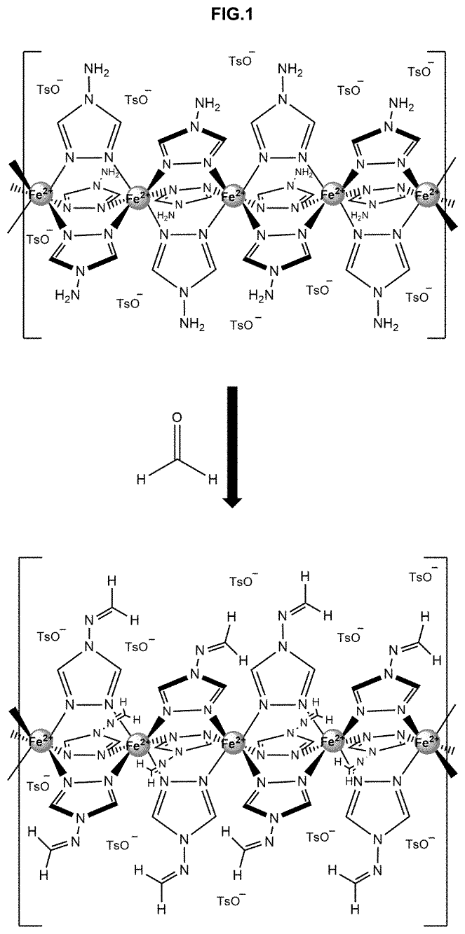

When contacted with formaldehyde vapors, a covalent post synthetic modification (C-PSM), in the form of a nucleophilic addition, takes place leading to the formation of the corresponding imine derivative (Compound 2) and water, as shown in the scheme depicted in FIG. 1.

Compound 2 was synthetized by following the ensuing general procedure. A screw vial for chromatography (diameter 12 mm, height 32 mm) containing 20 mg of 1 was placed in a clear glass simple vial (diameter 27 mm, height 55 mm) provided with 0.2 ml of formaldehyde. The glass simple vial was sealed and kept at room temperature overnight to allow the gas-solid reaction between the corresponding volatile organic compound and 1.

FIG. 1 shows the scheme of the reaction between (1) and formaldehyde to yield (2). The structure of the coordination polymer (1) before exposed to formaldehyde is depicted in the top image, while that of the imine derivative (2) after being exposed to formaldehyde is represented in the bottom image.

This C-PSM was confirmed by proton nuclear magnetic resonance (¹H NMR) on (2) after digestion of a sample in a deuterated aqueous solution of K₃PO₄ followed by a D₂O/CDCl₃ extraction.

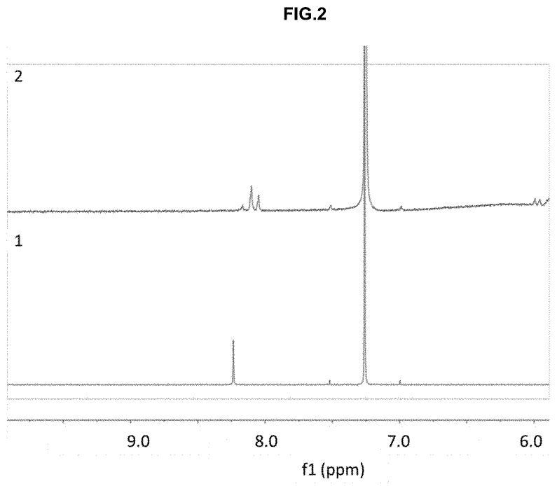

The NMR spectrum for the compound containing an imine moiety displayed the characteristic signal corresponding to a primary imine, a singlet at δ=8.05 ppm integrated by the two protons corresponding to —N═CH₂, and the corresponding signals from the methylene groups of the triazole rings (δ=8.10 ppm). The gas-solid phase C-PSM is complete (the ¹H signal associated to the amino group in NH₂Trz in 1 are absent in the NMR spectra of compound 2, as shown in FIG. 2).

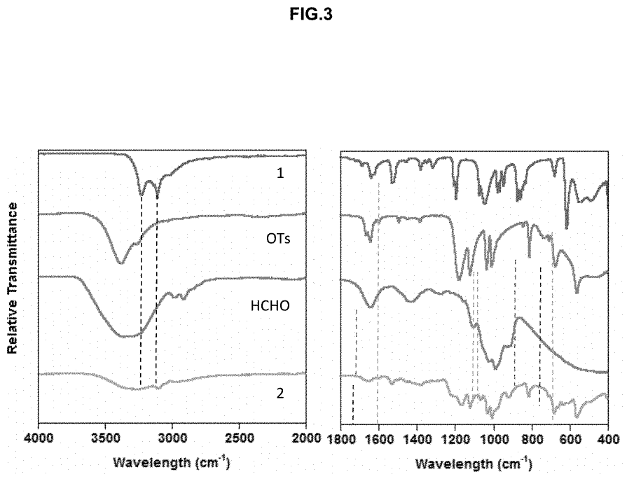

Identification of the functional group imine in (2), replacing the NH₂ pendant groups of compound (1) was also performed by infra-red (IR) spectroscopy. The absorption band corresponding to the C—N stretching mode in the N═CH₂ moiety appears at 1659 cm⁻¹, while the NH stretching mode centered at 3167 cm⁻¹ is absent. Remarkably, the C═O stretching band from formaldehyde at 1645 cm⁻¹ is absent in compound 2. The IR spectrum of 1 and 2 is represented in FIG. 3. Compound 1 is represented on the top of the spectrum, while compound 2 is represented at the bottom. The second from the top corresponds to tosylate, while the second from the bottom corresponds to formaldehyde.

2 displays different physical and chemical properties compared to 1. The latter is a SCO compound whereas the iron centers in 2 remain in the HS state irrespective of temperature. The SCO phenomena in 1 can be easily seen by nacked eyes in the form of a reversible color change from lilac to white when heating (LS→HS) and back to lilac when cooling (HS→LS). Interestingly, when 1 is exposed to formaldehyde, the color changes from lilac to white even at room temperature, as a result of the LS→HS spin transition that takes place.

### Preparation of the Composite Material 1-PMMA:

1-PMMA films can be prepared by dissolving 1 g of PMMA in 10 mL of CHCl₃ in a first step. Afterwards, it was sonicated for 10 minutes and 1 g of compound 1 was added. The mixtures has to be further sonicated for over 20 minutes, and then poured in a 5×5 cm Teflon mold. After setting for a few hours, a 1-PMMA film of approximately 2 mm of thickness was easily removed from the Teflon mold.

1-PMMA films are stable up to 220° C. (weight loss corresponds to released water molecules) and show the expected SCO phenomena. Noteworthy, preliminary results confirm that 1-PMMA films react with formaldehyde vapors in the same way as powdered compound 1 does, giving the same optical response in the presence of formaldehyde, thus making 1-PMMA films a very promising easy-to-use formaldehyde sensor.

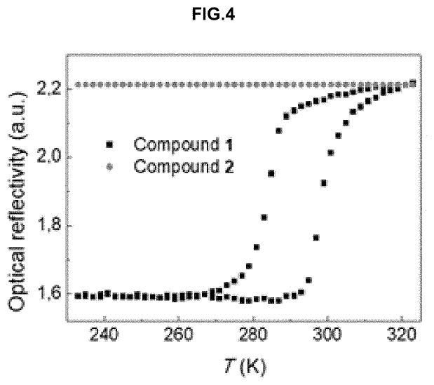

The optical reflectivity of complexes 1 and 2 was measured between 233 K and 333 K. FIG. 4 depicts, on the one hand, an abrupt spin transition for compound 1, with a hysteresis of 12 K. The transition takes place between 267 K and 317 K, with transition temperatures T½↓=285 K and T½↑=297 K. On the other hand, compound 2 remains in the HS state for the whole range of temperatures.

Optical Reflectivity Measurements of Compound 1 after being Exposure to VOC's.

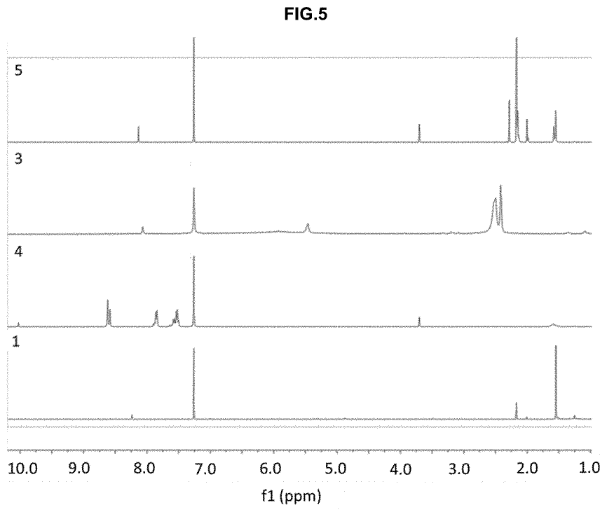

To further investigate the potential of the compound of the invention as a sensor material, compound 1 was exposed to other volatile organic compounds, such as formic acid, benzaldehyde and acetone. C-PSM reactions were confirmed by IR and ¹H-NMR spectroscopic techniques. FIG. 5 compares ¹H-NMR spectra of compounds 1, 3, 4 and 5.

1 corresponding to compound 1, {[Fe(NH₂Trz)₃](OTs)₂}ₙ.

3 corresponds to compound 1 after being exposed to formic acid vapors.

4 corresponds to compound 1 after being exposed to benzaldehyde vapors.

5 corresponds to compound 1 after being exposed to acetone vapors.

The normalized reflectivity vs. temperature was also measured for benzaldehyde, acetone and acetic acid, as well as ammonia and hydrochloric acid. The following table summarizes the values obtained at room temperature (approximately 298 K) and the displayed color of compound 1 after being exposed to vapors of each of the studied compounds.

TABLE 1
Optical reflectivity values of compounds 1-7 at 298 K and
corresponding colorimetric responses.

| | Optical reflectivity (UV- | Displayed color |
|---|---|---|
| Compound | vis absorption) T = 298 K | at T = 298 K |
| blank | ~520 nm | Lilac |
| formaldehyde | — | White |
| acetaldehyde | ~520 nm | Lilac |
| butyraldehyde | ~520 nm | Lilac |
| benzaldehyde | ~520 nm | Lilac |
| acetone | ~520 nm | Lilac |
| acetic acid | ~520 nm | Lilac |
| ammonia | ~520 nm | Brown |
| hydrochloric acid | ~520 nm | Yellow |

The comparative tests between the four volatile aldehydes ran in this table show the remarkable high selectivity of the coordination polymer of the present invention, being formaldehyde the only analyte detected by a proper colorimetric response.

### Example 2

A coordination polymer (CP) comprising repeating coordination complexes of formula {Fe(NH₂trz)₃(Br)₂} (namely CPBr1), was synthetized as described in Example 1 but using FeBr₂ as starting material.

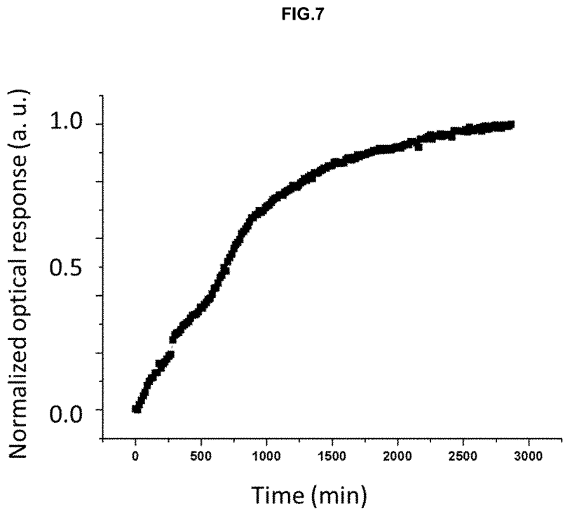

When CPBr1 is put in contact with formaldehyde in a similar experiment as the one described in Example 1, the compound shows a detectable spectroscopic response. In particular it shows a colorimetric response that can be detected by the human naked-eye (from lilac to white). This response is caused by the formation of a new compound (namely CPBr2) comprising an imine derivative. FIG. 7 below, shows the change in optical reflectivity of CPBr being exposed to formaldehyde at room temperature (being 0 lilac color and 1 white color). The authors have observed that the coordination complexes CPBr1 and CPBr2 in contact with formaldehyde show a detectable spectroscopic response. In addition, complexes CPBr1 and CPBr2 maintained their optical properties when embed in a polymeric matrix such as PMMA following a procedure similar to the one described in Experiment 1.

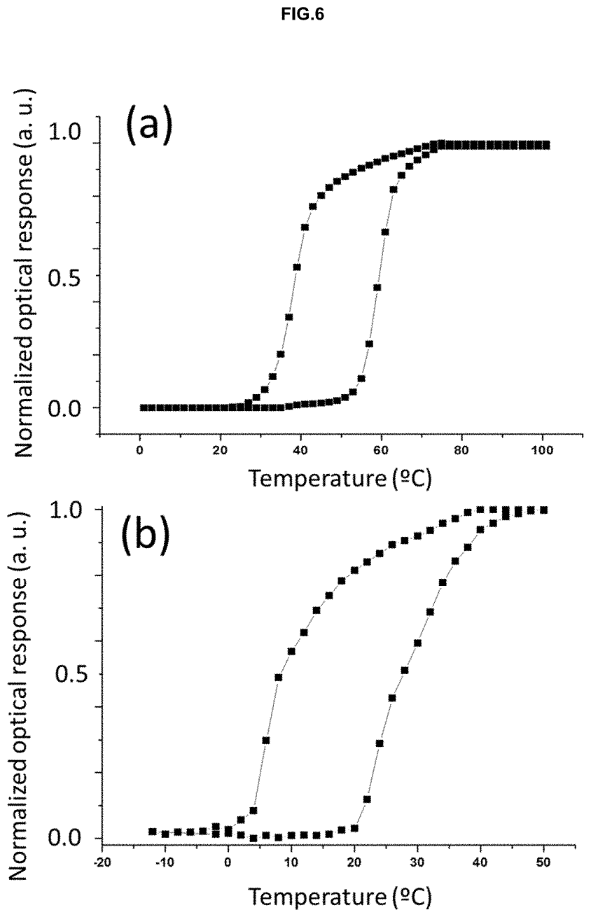

The optical reflectivity of complexes CPBr1 and CPBr2 was measured between 0 and 100° C. (FIG. 6). FIG. 6 shows that the optical reflectivity of (a) CPBr1 and (b) CPBr2 changed with the temperature. By comparing results from FIG. 4 and FIG. 6, the authors have observed that the type of counter-ion used in the coordination complexes changed the optical response of the coordination complexes to temperature. For example, the optical reflectivity of the imine coordination complex comprising Br— ions changed with the temperature (see FIG. 6b directed to the optical reflectivity vs temperature of CPBr2) while the imine coordination complex comprising tosylate ions, did not change with temperature (see FIG. 4 of the description directed to compound 2 as named in Experiment 1). The stability over temperature of the coordination complex having a counter ion comprising an aromatic moiety once reacted with formaldehyde (such as compound 2), might be an additional advantage.

1.-24. (canceled)

25. A method for the identification and/or quantification of formaldehyde comprising using a coordination polymer, wherein the coordination polymer comprises repeating coordination complexes with an octahedral geometry, wherein said coordination complex comprises:
iron(II);
at least one ligand comprising an amino moiety;
wherein the coordination polymer further comprises counter-ions;
in a detectable spectroscopic response.

26. The method of the coordination polymer according to claim 25, wherein the at least one ligand comprising an amino moiety comprises a primary amine; and/or wherein the at least one ligand comprising an amino moiety is selected from aniline, 4-amino-4H-1,2,4-triazole (NH₂Trz) and 3-amino-1,2,4-triazole.

27. The method of the coordination polymer according to claim 25, comprising contacting the coordination polymer, with a gaseous, liquid or solid analyte to produce a non-reversible reaction, wherein said reaction produces a detectable spectroscopic response.

28. The method of the coordination polymer according to claim 25, wherein the counter-ions comprise an aromatic moiety or an ion selected from fluoride (F⁻), chloride (Cl⁻), bromide (Br⁻), iodide (I⁻) and a combination thereof; or wherein the counter-ions are bromide ions (Br⁻).

29. The method of the coordination polymer according to claim 25, wherein the counter-ions comprise an aromatic moiety; or wherein the counter-ions are tosylate counter-ions.

30. The method of the coordination polymer according to claim 25, wherein the coordination polymer is {[Fe(NH₂Trz)₃](OTs)₂}ₙ.xH₂O, wherein n≥3, x is between 0 and 20, wherein (NH₂Trz)=4-amino-4H-1,2,4-triazole, and (OTs)=para-toluenesulfonate.

31. The method of the coordination polymer according to claim 25, wherein the detectable spectroscopic response is a colorimetric response that can be detected by the human naked-eye.

32. A composite material comprising:
(i) a coordination polymer, wherein the coordination polymer comprises repeating coordination complexes with an octahedral geometry, wherein said coordination complex comprises:
iron(II);
at least one ligand comprising an amino moiety;
wherein the at least one ligand comprising an amino moiety comprises a primary amine (NH₂);
wherein the coordination polymer further comprises counter-ions comprising an aromatic moiety and wherein the counter-ions are tosylate counter-ions;
(ii) a matrix;
wherein the coordination polymer of (i) is embedded in and/or coating the matrix of (ii).

33. The composite according to claim 32, wherein the matrix is a thermostable compound; and/or wherein the matrix comprises an acrylic or acrylate polymer.

34. The composite according to claim 32, wherein the at least one ligand comprising an amino moiety is selected from aniline, 4-amino-4H-1,2,4-triazole (NH₂Trz) and 3-amino-1,2,4-triazole.

35. The composite according to claim 32, wherein the coordination polymer is {[Fe(NH₂Trz)₃](OTs)₂}ₙ.xH₂O, wherein n≥3, x is between 0 and 20, and wherein (NH₂Trz)=4-amino-4H-1,2,4-triazole, and (OTs)=para-toluenesulfonate.

36. A method for the identification and/or quantification of formaldehyde comprising using the composite according to claim 32 in a detectable spectroscopic response.

37. A hand-held portable device comprising the composite according to claim 32 and a suitable case.

38. A method for the identification and/or quantification of formaldehyde comprising using a hand-held portable device according to claim 37 in a detectable spectroscopic response.

39. A method for the identification and/or quantification of formaldehyde, wherein the method comprises:
contacting either:
a coordination polymer;
a composite material comprising said coordination polymer and a matrix; wherein the coordination polymer is embedded in and/or coating the matrix, or
a hand held device comprising the composite material and a suitable case;
with a gaseous, liquid or solid analyte to produce a non-reversible reaction, wherein said reaction produces a detectable spectroscopic response;
wherein the coordination polymer comprises repeating coordination complexes with an octahedral geometry, wherein said coordination complex comprises:
iron(II); and
at least one ligand comprising an amino moiety;
wherein the coordination polymer further comprises counter-ions.

40. The method according to claim 39, wherein the detectable spectroscopic response obtained is compared with a concentration colored map generated by converting the reflectance spectra of several coordination polymers or composite materials, wherein said coordination polymers or composite materials have been contacted with well-defined, known concentrations of formaldehyde, into RGB values and subtracting the control image.

41. The method according to claim 39, wherein the counter-ions of the coordination polymer comprise an aromatic moiety or an ion selected from fluoride (F⁻), chloride (Cl⁻), bromide (Br⁻), iodide (I⁻) and a combination thereof.

42. The method according to claim 39, wherein the counter-ions of the coordination polymer comprise an aromatic moiety.

43. The method according to claim 39, wherein the at least one ligand comprising an amino moiety comprises a primary amine (NH₂); or wherein the at least one ligand is selected from aniline, 4-amino-4H-1,2,4-triazole (NH₂Trz) and 3-amino-1,2,4-triazole.

44. A process for preparing the composite as defined in claim 32, comprising the following steps:
(i) providing a matrix;
(ii) providing the coordination polymer as defined in claim 32; and
(iii) combining the matrix (i) and the coordination polymer (ii).
